(19) United States
(12) Patent Application Publication
(10) Pub. No.: US 2017/0268761 A1
(43) Pub. Date: Sep. 21, 2017

(54) HEAT DISSIPATION LIGHT RING

(71) Applicant: XIAMEN ECO LIGHTING CO. LTD., Xiamen (CN)

(72) Inventors: Maojin Zeng, Xiamen (CN); Liangliang Cao, Xiamen (CN); Xiaobo Chen, Xiamen (CN); Yongzhe Dong, Xiamen (CN); Yongjun Bao, Xiamen (CN); Jinzhui Chen, Xiamen (CN); Yunnan Lin, Xiamen (CN)

(21) Appl. No.: 15/508,475

(22) PCT Filed: Jul. 20, 2016
(86) PCT No.: PCT/CN2016/090579

§ 371 Date: Mar. 2, 2017

(30) Foreign Application Priority Data
Nov. 5, 2015 (CN) 201510744137.2

(51) Int. Cl. F21V 29/15; F21V 29/00; F21V 29/87

(52) U.S. Cl. CPC F21V 29/15; F21V 29/87; F21K 9/235

(57) ABSTRACT

A heat dissipation light ring that includes a light source board, a heat transferred layer and an insulating layer. The insulating layer is set outside of the heat transferred layer. The heat transferred layer includes heat conductive part and heat transferred part. The heat conductive part is related to the light source board with heat and set tilted compared with the heat conductive part. The heat dissipation light ring includes heat transferred wall. One end of the heat transferred wall is related to heat conductive part with heat, and the other end of the transferred wall is related to heat transferred part. The insulating layer is set outside of the heat transferred layer and heat transferred wall. The heat dissipation light ring owns the advantage of the high thermal efficiency.

### TECHNICAL FIELD

The present invention is related to an LED lighting field and more particularly related to a heat dissipation light ring that may be used for an LED light.

### BACKGROUND

Considering the overheating phenomena that lighting diode works will happen, a lighting diode needs to combine a heat dissipation device to achieve the purpose of heat dissipation. Nowadays, LED lighting applications are used more and more widely. The light source of LED will send out a large amount of heat while using it. The stronger the power is, the more the heat sends out. If an LED light is all made from the plastic ingredients, the qualification of small thermal conductivity and the slow speed of heat transferring will affect the speed and efficiency of heat propagation. Making the heat dissipation device's temperature rise also affects the normal work for LED light. The over high temperature will easily lose the function and affect the safety of lighting device usage.

### SUMMARY OF INVENTION

In view of this, it is necessary to provide a heat dissipation light ring with the high-efficiency heat dissipation.

The technical solution for the present invention is a heat dissipation light ring that includes a light source board, a heat transferred layer and an insulating layer. The insulating layer is set outside of the heat transferred layer. The first feature is that the heat transferred layer includes heat conductive part and heat transferred part. The second one is that the heat conductive part is related to the light source board with heat and set tilted compared with the heat conductive part. The third one is that includes heat transferred wall. One end of the heat transferred wall is related to heat conductive part with heat, and the other end of the transferred wall is related to heat transferred part. The final one feature is that the insulating layer is set outside of the heat transferred layer and heat transferred wall.

Comparing with the existed technology, the heat dissipation light ring sets the heat transferred layer, the heat transferred wall related to the heat transferred layer, and the insulating layer set outside of the heat transferred layer and the heat transferred wall.

Through this way, the heat that the light source board makes may rapidly transfer to the insulating layer. Moreover, it may effectively increase the face the heat transferred layer and the insulating layer touched to increase the efficiency that the heat transfers to the insulating layer by setting the heat transferred wall. All of them mentioned above increase the thermal efficiency of a heat dissipation light ring and the usage life of the LED light.

### BRIEF DESCRIPTION OF DRAWINGS

FIG. 1 is the first embodiment stereoscopic decomposition drawing for the present invention, a heat dissipation light ring.

FIG. 2 is the sectional drawing from FIG. 1 that illustrates the heat dissipation light ring.

### DETAILED DESCRIPTION

The attached drawing and the embodiment is to describe the present invention detailed in following statement.

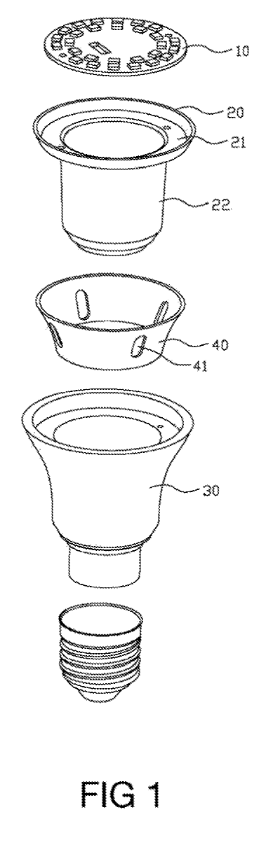

FIG. 1 illustrates a first embodiment according to the present invention, a heat dissipation light ring. The heat dissipation light ring includes a light source board (10), a heat transferred layer (20), and an insulating layer. The insulating layer (30) is set outside of the heat transferred layer (20).

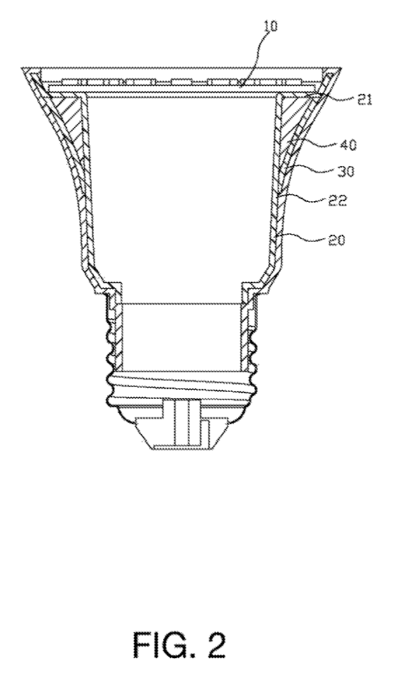

Please refer to FIG. 1 and FIG. 2, the heat transferred layer (20) includes the heat conductive part (21) and the heat transferred part (22). The heat conductive part (21) is related to the light source board (10) with heat and set tilted compared with the heat conductive part. The heat transferred part (22) is hollow structure set at the bottom of the heat conductive part (21). The top of the light source board (10) set an LED light source. The bottom of the light source board (10) is related to the heat conductive part with heat.

In FIG. 1 to FIG. 2, the heat dissipation light ring includes a heat transferred wall (40). The heat transferred wall (40) is circle structure. One end of the heat transferred wall is related to the heat conductive part (21) with heat, the other end of the heat transferred wall (40) is related to the heat transferred part (22). The insulating layer is set outside of the heat transferred layer (20) and the heat transferred wall (40). Moreover, the heat transferred layer (20) and the heat transferred wall (40) are all made of the metal ingredients. There is a hole (41) between the heat transferred wall (40) and the heat transferred layer (20). The insulating layer (30) is set outside of the heat transferred layer (20) and the heat transferred wall (40) and entered into the hole (41) to make the insulating layer be filled between the heat transferred layer (20) and the heat transferred wall. Among them, the hole (41) is set on the heat transferred wall (40). Moreover, the insulating layer (30) is made of thermal plastic ingredient. In this embodiment, the insulating layer (30) is set outside of the heat transferred layer (20) and the heat transferred wall (40) by an injection molding and a squeeze out skills.

While working, the heat produced by the light source of the light source board (10) first transfer to the heat transferred layer's (20) heat conductive part. One part of the heat goes through the heat conductive part (21) and then rapidly transfer to the heat transferred wall. (40) The other part of the heat goes through the heat transferred part (22) first and then transfer to the heat transferred wall. (40) Moreover, transferring the heat to the insulating layer that exclusive of the heat transferred layer (20) and the heat transferred wall (40) increases the speed of transferring the heat in the insulating layer (30). At last, the heat may transfer to outer space through the insulating layer. (30)

In conclusion, the heat dissipation light ring sets the heat transferred layer (20), the heat transferred wall (40) related to the heat transferred layer (20), and the insulating layer (30) set outside of the heat transferred layer (20) and the heat transferred wall. (40) Through this way, the heat that the light source board (10) makes may rapidly transfer to the insulating layer (30). Moreover, it may effectively increase the face the heat transferred layer (20) and the insulating layer (30) touched to increase the efficiency that the heat transfers to the insulating layer (30) by setting the heat transferred wall. (40) Comparing with the traditional whole plastic-made heat dissipation light ring, it increases the thermal efficiency of a heat dissipation light ring and the usage life of the LED light.

The statement above just for the better embodiment, not for limiting the present invention. Based on the range of this technical plan, each person in this field may change the technology mentioned above for equal effectiveness to the embodiment. All the modification, equal to any change and improvement that are based on our invention's spirit and principle, may be protected in our invention protection range.

1. A heat dissipation light ring comprising a light source board, a heat transferred layer and an insulating layer, the insulating layer set outside of the heat transferred layer, characterized in that: the first feature is the heat transferred layer comprises heat conductive part and heat transferred part; the second one is the heat conductive part is related to the light source board with heat and set tilted compared with the heat conductive part; the third one is the heat dissipation light ring comprises heat transferred wall; one end of the heat transferred wall is related to heat conductive part with heat, and the other end of the transferred wall is related to heat transferred part; the final one feature is the insulating layer is set outside of the heat transferred layer and heat transferred wall.

2. The heat dissipation light ring of claim 1, characterized in that: a hole between the heat transferred wall and the heat transferred layer; the insulating layer is set outside of the heat transferred layer and the heat transferred wall and entered into the hole.

3. The heat dissipation light ring of claim 2, characterized in that: the hole is set on the heat transferred wall.

4. The heat dissipation light ring of claim 2, characterized in that: the insulating layer is set outside of the heat transferred layer and the heat transferred wall by an injection molding and a squeeze out skills.

5. The heat dissipation light ring of claim 1, characterized in that: the heat transferred layer and the heat transferred wall are all made of the metal ingredients.

6. The heat dissipation light ring of claim 5, characterized in that: the heat transferred part is hollow structure set at the bottom of the heat conductive part, and the heat transferred wall is circle structure.

7. The heat dissipation light ring of claim 1, characterized in that: the insulating layer is made of thermal plastic ingredient.

8. The heat dissipation light ring of claim 1, characterized in that: the top of the light source board set an LED light source; the bottom of the light source board is related to the heat conductive part with heat.
